(19) United States
(12) Patent Application Publication
(10) Pub. No.: US 2024/0111918 A1
(43) Pub. Date: Apr. 4, 2024

(54) METHOD OF CALIBRATING A THERMAL FEM-MODEL

(71) Applicant: MTU Aero Engines AG, Muenchen (DE)

(72) Inventors: Nadia ZERELLI, Munich (DE); Yannick MULLER, Groebenzell (DE); Giulia ANTINORI, Bologna (IT)

(21) Appl. No.: 18/506,539

(22) Filed: Nov. 10, 2023

(51) Int. Cl. G06F 30/15

(52) U.S. Cl. CPC G06F 30/15

(57) ABSTRACT

The present invention relates to a method of calibrating a thermal FEM-model of a turbomachine, the method comprising: i) creating a meta-model of the thermal FEM-model; ii) feeding, for a set of thermal variables, a set of input values to the meta-model for a calculation in the meta-model; iii) obtaining a set of output values from the calculation in the meta-model for the set of input values; iv) comparing the set of output values to measurement data of the turbomachine.

The work leading to this invention has received funding from the European Union's Seventh Framework Programme (FP7/2007-2013) for the Clean Sky Joint Technology Initiative under grant agreement no. CSJU-GAM-SAGE-2008-001.

### TECHNICAL FIELD

The present disclosure relates to a method of calibrating a thermal FEM-model of a turbomachine.

### BACKGROUND

The operation of a turbomachine, e. g. jet engine, causes its components and parts to heat up. The resulting temperatures and temperature distribution may also influence mechanical boundary conditions and fits. Therefore, modelling the thermal behaviour with an appropriate thermal FEM-model (finite element method, FEM) may be an important prerequisite for any subsequent modelling and design steps, for example so called “engine gapping” or clashing analyses to evaluate a fit or clearance between individual parts at different temperatures or operation points of the turbomachine.

### SUMMARY OF THE INVENTION

Particular embodiments and features are provided in this description and in particular in the appended claims.

In the embodiment of claim 1, a meta-model of the thermal FEM-model is created (step i). To this meta-model, a set of input values is fed (step ii), wherein a set of output values is obtained from the calculation in the meta-model (step iii). These output values may be compared to measurement data of the turbomachine (step iv), e. g. to determine whether or to which degree the output values and, vice versa, the respective input values are appropriate to reproduce the measurements.

Performing the calibration, for instance at least some iterations thereof, not at the thermal FEM-model itself but at the meta-model instead may reduce calculation time and, in consequence, the time for prototyping or any further development and design steps. In this respect, the application aims at accelerating development and also admission processes by reducing calculation time. This may, in addition to other measures discussed below, be achieved by outsourcing at least a part of the calculation to the meta-model which is, in simple words, a simplified substitute of the thermal FEM-model itself.

The thermal FEM-model may in particular represent a module or submodule of the turbomachine, for instance a submodule of the compressor or the turbine, like for example high pressure turbine or low pressure turbine. As to the physical modelling, the thermal FEM-model may for instance consider heat conduction, heat convection and/or heat radiation.

In general words, a thermal variable may be a boundary condition of the FEM-model, for instance like the angle of an airflow impinging on a metal part, the emission coefficient of a given material and surface, the contact force of neighbouring parts mechanically linked via flange, the core rotation factor of airflow in a rotor drum. As detailed below, the set of thermal variables may in particular be a subset of a plurality of thermal variables, namely a reduced and selected number of thermal variables (e. g. by sensitivity analysis, see below).

The meta-model, e. g. substitute of the thermal FEM-model, may be obtained by generating response functions of the thermal FEM-model and fitting these response functions. The response functions can in particular result from a plurality or matrix of simulations in the thermal FEM-model, where the result is from a mathematical point of view a multi-dimensional equation system or point cloud. This is approximated by regression, for instance by linear, quadratic or polynomial regression. Alternatively or in addition, a spline regression or Gaussian process regression, e. g. Kriging, may be applied. When the meta-model reproduces the thermal FEM-model it may proceed to further calibration. Alternatively, a further iteration with calculating additional response functions may be performed.

Considering, by way of example, a parallel development and prototyping process, the creation of the meta-model, that may include comparably time-consuming FEM simulation steps, may be performed in parallel to or even before any measurements are made. Thus, considering the overall development cycle, at least some of the possibly time-consuming simulation work may be frontloaded, which can reduce a bottleneck later on.

The meta-model may in particular allow for a parallel variation of a plurality of thermal variables. In other words, different sets of input values may be calculated, in particular simultaneously. Independently of whether or to which degree the calculation is parallelized, the meta-model allows for probing a plurality of different sets of input values. In particular, these iterations may be performed until a matched set of output values is obtained, which provides the best fit to the measurement data (e. g. only minor or no deviation).

The matched set of input values, which delivered the matched set of output values in the meta-model, may be provided to the thermal FEM-model in a next step. The calculation in the thermal FEM-model delivers FEM output values which may for instance be compared to the matched output values of the meta-model. In particular, the FEM output values can be compared to the measurement data to evaluate whether the simulation fits the measurement. If not or not sufficiently, a new iteration of the meta-model creation may be triggered, otherwise the thermal FEM-model with the matched set of input values may proceed as a calibrated model.

Considering all thermal variables of the thermal FEM-model, for instance only a subset thereof may be fed to the calibration process. This subset may be derived from a sensitivity analysis, so that thermal variables with no or only a minor impact on the output of the FEM calculation are sorted out upfront. As discussed above for the meta-model creation, this “preparatory” work may be performed independently of any measurement data, e. g. in an early stage of the development cycle. Vice versa, having ruled out variables with less or a minor impact may accelerate the actual calibration later on, e. g. once measurement data is available.

The sensitivity analysis may comprise a matrix of simulations with the thermal FEM-model. Upfront, for each thermal variable a validity range may be defined (e. g. min/max value), wherein the input values for the simulation matrix are then chosen within these validity ranges, e. g. stochastically. In a sense, this allows for a probing of each thermal variable within its validity range.

The output values obtained from these FEM simulations may be evaluated to determine those thermal variables which have an influence, for instance by an elementary effect or a coefficient of importance method. Alternatively or in addition, a correlation analysis of the output values may deliver the kind of correlation between the respective thermal variable and the output values. In addition to ruling out thermal variables with no or only a minor impact, the remaining thermal variables may also be sorted according to their relevance. Independently of these details, feeding the subset of thermal variables to the calibration in the meta-model may reduce calculation time further, see above.

### BRIEF DESCRIPTION OF THE DRAWINGS

The application is explained more in detail below by means of an exemplary embodiment, with the individual features also being relevant in other combinations and relating to all claim categories.

FIG. 1 shows a schematic cross-section of a turbomachine;

FIG. 2 shows a flow diagram illustrating several method steps;

FIG. 3 shows a further flow diagram illustrating method steps.

### DETAILED DESCRIPTION

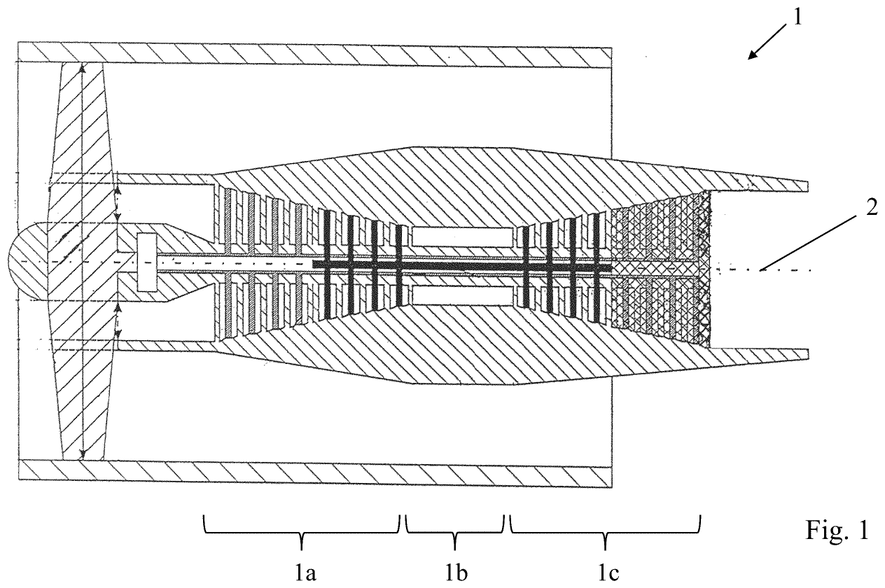

FIG. 1 shows a turbomachine 1, specifically a turbofan engine, in an axial section. The turbomachine 1 is functionally divided into compressor 1a, combustion chamber 1b and turbine 1c. Both the compressor 1a and the turbine 1c are each made up of several stages, each stage comprising a stator vane ring and a rotor blade ring. During operation, the rotor blade rings rotate around the longitudinal axis 2 of the turbomachine 1, and air sucked in is compressed in the compressor 1a and then burned with fuel, for instance kerosene, in the combustion chamber 1b. The resulting hot gas is expanded in the turbine 1c and drives the rotor blade rings.

This combustion process, but for instance also the compression, leads to heating during operation. The temperatures that the individual components have may influence the mechanical fits and stresses in the engine, e. g. due to thermal expansion. Component temperatures are therefore an important parameter in the evaluation of mechanical integrity and service life, as well as in the calculation of component displacements, for instance so-called engine gapping or clashing analyses. Such calculations require a thermal FEM-model.

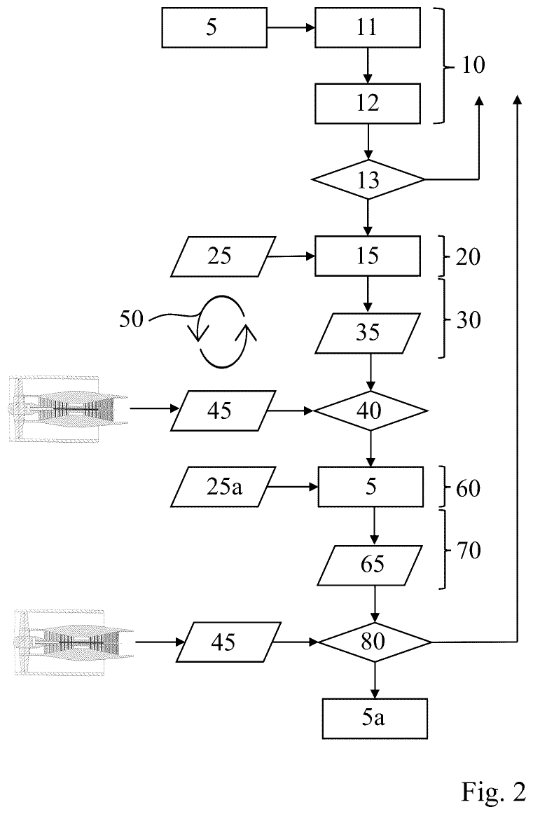

FIG. 2 shows a flow diagram which summarizes several method steps in the calibration of a thermal FEM-model 5 of the turbomachine. With the calibration, thermal variables, which are boundary conditions of the thermal FEM-model, are modified such that the calibrated model reflects temperatures that have been measured by sensors at different positions in the turbomachine, e. g. gas temperatures measured at various locations in the gas channel and component temperatures measured at different components. In simple words, the calibrated model fits to or reproduces the temperatures measured.

As illustrated in FIG. 2, this calibration is not or not only performed with the thermal FEM-model 5 itself, instead a meta-model 15 of the thermal FEM-model 5 is created 10. For this, response functions are generated 11 by simulation in the thermal FEM-model 5, wherein these FEM-model responses deliver an equation system. This equation system is then fitted by regression, which may for instance be a polynomial or spline-regression.

In an evaluation step 13 it may be decided whether the response functions of the thermal FEM-model are reproduced sufficiently. If so, the meta-model 15 may proceed to further calibration of the thermal FEM-model 5, otherwise the aforementioned steps may be repeated.

Instead of varying or modifying thermal variables in the thermal FEM-model 5 itself, a set of input values 25 is fed 20 to the meta-model 15. From the calculation in the meta-model 15, a set of output values 35 is obtained 30. By comparing 40 these output values 35 to measurement data 45 obtained from sensor measurement in the turbomachine 1, a deviation or fit of the input values 25 can be determined. The calculation in the meta-model 15 may be performed 50 a plurality of times with different sets of input values 25 to determine a matched set of input values 25a whose output values 35 fit the measurement data 45 best.

The matched set of input values 25a may be provided 60 to the thermal FEM-model 5 to obtain 70 FEM output values 65 from the thermal FEM-model 5. By comparing 80 these FEM output values 65 to the measurement data 45, a match between the (calibrated) thermal FEM-model 5 and the measurements on the turbomachine 1 can be determined. In case of a minor or no deviation, the thermal FEM-model 5 with the matched set of input values 25 may proceed as a calibrated thermal FEM-model 5a, for instance to be used in structural mechanical or in particular engine gapping analysis.

Otherwise, in case that the recalculation of the matched input values 25a in the thermal FEM-model 5 does, in contrast to the calculation in the meta-model 15, not show any convergence with the measurements, a new meta-model and in particular additional response functions may be generated 11 to aim at a better fit between the meta-model 15 and the thermal FEM-model 5.

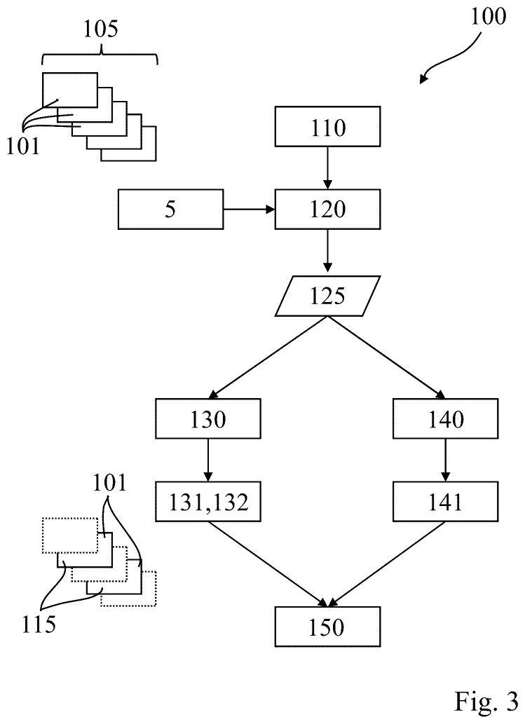

The flow diagram of FIG. 3 illustrates a sensitivity analysis 100 that may be performed upfront to reduce the number of variables to be considered in the calibration of the thermal FEM-model 5. This may reduce an initial set 105 of thermal variables 101 that would have to be considered in the calibration process to a subset 115, which may allow for less calculation effort and time in the calibration process. Further, the sensitivity analysis may be even done prior to performing any measurements, for instance before any prototype of a new development is available. Vice versa, once measured data is available, the variable reduction achieved by the sensitivity analysis 100 may accelerate the calibration.

For the sensitivity analysis 100, for each thermal variable 101 a validity range may be defined 110, typically by providing min/max values. This is also referred to as “sampling”. Within these validity ranges, different sets of input values are chosen for performing 120 a matrix of simulations with the thermal FEM-model 5. These input values may particularly be chosen stochastically.

For a postprocessing of output values 125 obtained from the matrix of FEM simulations, different methods may apply. On one hand, the output values 125 are evaluated 130 by an elementary effect method 131. This may deliver “which” of the thermal variables 101 have a particular impact on the output values 125. As an alternative to the elementary effect method, this may also be obtained by a coefficient of importance method 132. An evaluation 140 by a correlation analysis 141, for instance by an a ANOVA algorithm, may deliver “how” the output of variables 125 correlate with the thermal variables 101 (for instance “increasing” vs. “decreasing” and so on).

With the sensitivity analysis 100, those thermal variables which have no or only a minor impact, or “do not correlate”, may be sorted out. In the subset 115 derived 150, the remaining thermal variables 101 may additionally be ranked according to their importance, e. g. impact on the output values 125.

### LIST OF REFERENCES

Turbomachine 1
Compressor 1a
Combustion chamber 1b
Turbine 1c
Longitudinal axis 2
Thermal FEM-model 5
Calibrated thermal FEM-model 5a
Creating (meta-model) 10
Generating (response functions) 11
Evaluation step 13
Meta-model 15
Feeding (input values) 20
Input values 25
Matched input values 25a
Obtaining (output values) 30
Set of output values 35
Comparing (output values to measurement data) 40
Measurement data 45
Performing (plurality of iterations) 50
Providing (matched input values to FEM-model) 60
FEM output values 65
Obtaining (FEM output values) 70
Comparing (FEM output values to measurement data) 80
Sensitivity analysis 100
Thermal variables 101
Initial set (of thermal variables) 105
Defining (validity ranges) 110
Subset (of thermal variables) 115
Performing (matrix of FEM simulations) 120
Output values (from matrix of FEM simulations) 125
Evaluating (output values) 130
Elementary effect method 131
Coefficient of importance method 132
Evaluating (output values) 140
Correlation analysis 141
Deriving (subset of thermal variables) 150

What is claimed is:

1. A method of calibrating a thermal FEM-model of a turbomachine, the method comprising:
i) creating a meta-model of the thermal FEM-model;
ii) feeding, for a set of thermal variables, a set of input values to the meta-model for a calculation in the meta-model;
iii) obtaining a set of output values from the calculation in the meta-model for the set of input values;
iv) comparing the set of output values to measurement data of the turbomachine.

2. The method of claim 1, wherein creating the meta-model in step i) comprises:
generating response functions of the thermal FEM-model;
fitting the response functions by regression.

3. The method of claim 2, wherein fitting the response functions comprises at least one of linear-, quadratic-, polynomial-, spline-, and Gaussian process-regression.

4. The method of claim 1, wherein steps ii) and ii) are performed a plurality of times and simultaneously.

5. The method of claim 1, wherein steps ii) to iv) are performed a plurality of times to determine, for a matched set of output values that best fits the measurement data, a matched set of input values.

6. The method of claim 5, further comprising:
providing the matched set of input values to the thermal FEM-model;
obtaining FEM output values from the thermal FEM-model;
comparing the FEM output values to the measurement data of the turbomachine.

7. The method of claim 1, wherein, prior to step ii), the set of thermal variables is derived as a subset of a plurality of thermal variables by a sensitivity analysis.

8. The method of claim 7, wherein the sensitivity analysis further comprises:
performing a matrix of simulations with the thermal FEM-model.

9. The method of claim 8, wherein the sensitivity analysis further comprises:
defining for each thermal variable a validity range, wherein input values for the matrix of simulations are obtained stochastically within the validity ranges.

10. The method of of claim 7, wherein the sensitivity analysis comprises:
evaluating an interaction between the thermal variables and respective output values by an elementary effect method and/or coefficient of importance method.

11. The method of claim 7, wherein the sensitivity analysis comprises:
evaluating an interaction between the original thermal variables and the respective output values by a correlation analysis.
